(19) United States
(12) Patent Application Publication
(10) Pub. No.: US 2024/0174259 A1
(43) Pub. Date: May 30, 2024

(54) VEHICLE CONTROLS SUPPORTING MULTIPLE ADS ECUS

(71) Applicant: Cummins Inc., Columbus, IN (US)

(72) Inventors: Upendra Kale, Pune (IN); Thaila Annamalai, Santa Clara, CA (US); Prasanna Srinivasan, Columbus, IN (US); Jorge A Sayegh, Indianapolis, IN (US); Jacob W. Bosch, Edinburgh, IN (US); Howard Robert Frost, Columbus, IN (US); Ethan Charles Seifer, Hope, IN (US); Craig Michael Calmer, Hope, IN (US)

(21) Appl. No.: 18/519,278

(22) Filed: Nov. 27, 2023

Related U.S. Application Data
(60) Provisional application No. 63/385,052, filed on Nov. 28, 2022.

(51) Int. Cl. B60W 60/00

(52) U.S. Cl. CPC B60W 60/001

(57) ABSTRACT

A vehicle system includes a plurality of automated driving system electronic control units (ADS ECUs) configured to determine vehicle motion control (VMC) commands in response to input from one or more vehicle environment sensors and transmit messages including the VMC commands over one or more communication links. An execution authority electronic control unit (EA ECU) is configured with execution authority over one or more VMC commands and is configured to receive, evaluate, and execute a VMC command associated with a received message.

### CROSS REFERENCE

The present disclosure claims priority to and the benefit of U.S. Application No. 63/385,052, filed Nov. 28, 2022, which is hereby incorporated by reference.

### TECHNICAL FIELD

The present application relates to vehicle controls supporting multiple automated driving system (ADS) electronic control units (ECUs) and related apparatuses, systems, and processes.

### BACKGROUND

Providing vehicle systems with automated driving system (ADS) capability and functionality poses a number of significant technical challenges including those respecting adaptability, reliability, safety, and other concerns. The possibility of including multiple ADS ECUs in a vehicle system heightens and confounds these and other challenges. There remains a significant need for the unique apparatuses, processes, and systems of the present disclosure.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include unique vehicle control systems supporting multiple automated driving system (ADS) electronic control units (ECUs). Some embodiments include unique vehicle control processes supporting multiple ADS ECUs. Some embodiments include unique vehicle control apparatuses supporting multiple ADS ECUs. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example vehicle system.

FIG. 2 is a schematic diagram illustrating certain aspects of an example vehicle control architecture.

FIG. 3 is a flow diagram illustrating certain aspects of an example control process for a vehicle system.

FIG. 4 is a flow diagram illustrating certain aspects of an example control process for a vehicle system.

### DETAILED DESCRIPTION OF EXAMPLE EMBODIMENTS

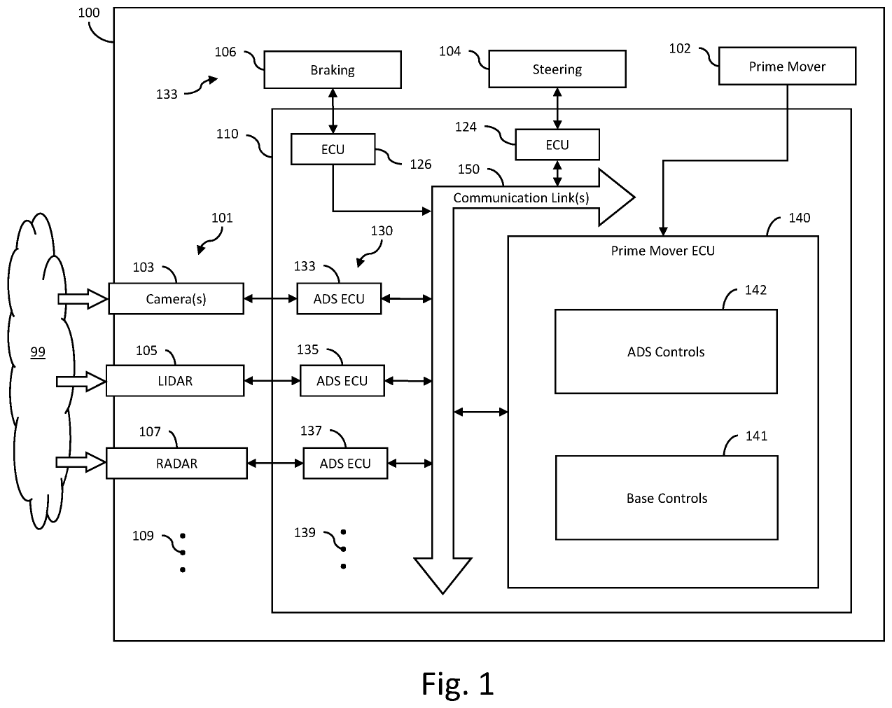

With reference to FIG. 1, there is illustrated an example vehicle system 100. Vehicle system 100 may be configured and provided in any of a number of forms including, for example, an on-highway vehicle (e.g., a truck, bus, or recreational vehicle), an off-highway vehicle, or various other types and categories of vehicles.

Vehicle system 100 includes vehicle motion control systems 133 (also referred to herein as systems 133). In the illustrated embodiment, systems 133 include a prime mover system 102, a steering system 104, and a braking system 106. In other embodiments, systems 133 may include additional or alternate systems capable of controlling or influencing motion of the vehicle system 100. Prime mover system 102 may be provided in a number of forms and may include, for example, an internal combustion engine, a battery/electric motor system, a hybrid internal combustion engine and battery/electric motor system, or other types of prime mover systems.

Vehicle system 100 includes vehicle environment sensors 101. In the illustrated embodiment, vehicle environment sensors 101 include one or more cameras 103, LIDAR 105, RADAR 107, and may also include other types of environment sensors suitable for use in connection with an automated driving system as is denoted by ellipsis 109. Some embodiments may include different types and/or combinations of vehicle environment sensors.

Vehicle system 100 includes electronic control system (ECS) 110 which is in operative communication with vehicle motion systems 133 and vehicle environment sensors 101.

ECS 110 includes a plurality of control components and structures including a number of electronic control units (ECUs). The ECUs generally include one or more programmable microprocessors or microcontrollers of a solid-state, integrated circuit type which are provided in one or more constituent control units of ECS 110. It is also contemplated that ECS 110 and its constituent ECUs may include other types of integrated circuits and/or discrete circuit control units including, for example, signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications. While a particular example implementation of ECS 110 is depicted in FIGS. 1, it shall be appreciated that ECS 110 can be implemented in any of a number of ways that combine or distribute the control function across one or more ECUs in various manners to implement and execute logic that defines various control, management, and/or regulation functions and may reside in dedicated hardware, such as a hardwired state machine, analog calculating machine, programming instructions, and/or a different form as would occur to those skilled in the art.

In the illustrated embodiment, electronic control system 110 includes a plurality of automated driving system electronic control units (ADS ECUs) 130 including ADS ECU 133, ADS ECU 135, and ADS ECU 137. ADS ECUs 130 may also include additional ADS ECUs as denoted by ellipsis 139, alternative or different ADS ECUs than the illustrated examples, or a different number of ADS ECUs such as two ADS ECUs or more than three ADS ECUs.

It shall be appreciated that automated driving systems comprise a number of systems that are configured to automate one or more aspects of vehicle motion control. Examples of automated driving systems include advanced driver assistance systems (ADAS) and other autonomous driving (AD) systems. Such systems may sometimes be categorized or classified at a number of levels including, for example, level 1 hands on/shared control, level 2 hands off, level 3 eyes off, level 4 mind off, and level 5 steering wheel optional.

ADS ECUs 130 are configured to determine vehicle motion control (VMC) commands in response to input from one or more vehicle environment sensors 101. In some embodiments, ADS ECUs are responsible for computing one or more of vehicle mission planning, dynamic driving needs of the vehicle in response to vehicle environment sensor input, and VMC commands. VMC commands may include longitudinal commands to control forward and reverse vehicle movement (e.g., vehicle acceleration/deceleration, speed, or position) as well as lateral commands to control lateral movement of the vehicle (e.g., vehicle steering). VMC commands may be executed by vehicle ECUs other than ADS ECUs of a vehicle. An ECU that has authority over and/or responsibility for the execution of VMC commands of ADS messages to effectuate control over vehicle motion may be referred to herein as an execution authority electronic control unit (EA ECU).

In some embodiments, VMC commands may command motion control through a torque request to a prime mover system (e.g., an engine and/or retarder system, or an electric motor system, or both). In some such embodiments, the VMC commands may include vehicle target speed parameters utilized by an EA ECU such as a prime mover ECU which may have with responsibility for or authority to maintain a reference speed based on the vehicle target speed. In some such embodiments, the VMC commands may include acceleration and/or deceleration request which an EA ECU such as a prime mover ECU may translate into appropriate torque/brake response to achieve the requested acceleration or deceleration.

In the illustrated embodiment, ADS ECU 133 is operatively coupled with and configured to receive input from one or more cameras 103 and to determine VMC commands in response to the received input. In other embodiments, ADS ECU 133 may be operatively coupled with and configured to receive input from additional ones of or different ones of vehicle environment sensors 101 or other vehicle environment sensors.

In the illustrated embodiment, ADS ECU 135 is operatively coupled with and configured to receive input from LIDAR system 105 and to determine VMC commands in response to the received input. In other embodiments, ADS ECU 135 may be operatively coupled with and configured to receive input from additional ones of or different ones of vehicle environment sensors 101 or other vehicle environment sensors.

In the illustrated embodiment, ADS ECU 137 is operatively coupled with and configured to receive input from RADAR system 107 and to determine VMC commands in response to the received input. In other embodiments, ADS ECU 137 may be operatively coupled with and configured to receive input from additional ones of or different ones of vehicle environment sensors 101 or other vehicle environment sensors.

It shall be appreciated that in some embodiments, one or more of ADS ECUs 130 may be operatively coupled with and configured to receive input from multiple ones of vehicle environment sensors 101 or other vehicle environment sensors. In some such embodiments, one or more of ADS ECUs 130 may be configured to perform sensor fusion operations that may combine, arbitrate, and/or utilize input from vehicle environment sensors. It shall likewise be appreciated that in some embodiments, one or more of ADS ECUs 130 may be operatively coupled with and configured to receive input from a common or shared one or more of vehicle environment sensors 101 or other vehicle environment sensors.

ADS ECUs 130 are configured to transmit messages including the VMC commands over one or more communication links 150. A communication link according to the present disclosure may include physical or hardware layer configured to implement a number of communication protocols including, for example, a controller area network (CAN), controller area network flexible data-rate (CAN-FD), an Ethernet, or other types of communication networks or communication links.

It shall be appreciated that communication links 150 may comprise a single communication link or network or a plurality of communication links or networks. When a plurality of communication links or networks are provided, the plurality of communication links may be distinct or separate from one another at a physical or hardware layer and/or a communication protocol layer. When a plurality of communication links or networks are provided, the various ECUs and other components of ECS 110 may be operatively coupled with and in operative communication with a single one of the plurality of the communication links, multiple ones of the plurality of communication links, or all of the plurality of communication links.

ECS 110 includes prime mover ECU 140 (also referred to herein as ECU 140) which is configured to control operation of prime mover system 102 and is operatively coupled with communication links 150 and configured for operative communication with other components of ECS 110 via communication links 150. ECU 140 may be configured and provided as an EA ECU and may therefore have authority the execution of VMC commands to control the operation prime mover system 102 to effect control over the motion of vehicle system 100.

In some embodiments, prime mover ECU 140 may be provided in and/or may operate in combination with multiple ECUs for multiple prime mover subsystems or components, for example, an engine ECU, a transmission ECU, a hybrid or power split ECU, an electric motor ECU, or various other prime mover system ECUs. One or more of such additional ECUs may also be configured and provided as an EA ECU and may therefore have some authority the execution of VMC commands to control the operation prime mover system 102 to effect control over the motion of vehicle system 100 which authority may be shared with ECU 140, delegated by ECU 140, and/or split or divided between ECU 140 and one or more of such other EA ECUs.

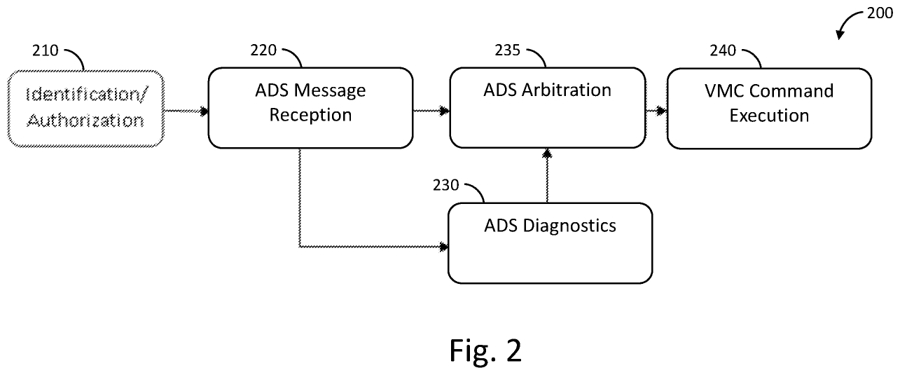

ECU 140 is provided with base controls 141 and ADS controls 142. Base controls 141 generally include controls configured and executable to control operation of prime mover system 102 which may operate without the presence or effect of any ADS messages or VMC commands. ADS controls 142 generally include controls configured and executable to process and/or execute ADS messages and VMC commands in connection with controlling operation of prime mover system 102. In some embodiments, ADS controls 142 may include some or all of controls 200 described in connection with FIG. 2.

ECS 110 includes steering ECU 124 (also referred to herein as ECU 124) which is configured to control operation of steering system 104. ECU 124 is operatively coupled with communication links 150 and configured for operative communication with other components of ECS 110 via communication links 150. ECU 124 has authority over the execution of commands to control steering system 104. ECU 124 may be configured and provided as an EA ECU and may therefore have authority the execution of VMC commands to control steering system 104 to effect control over the motion of vehicle system 100. ECU 124 may include base controls and ADS controls similar to the base controls and ADS controls of ECU 140, but configured and executable to control operation of steering system 104.

ECS 110 includes braking ECU 126 (also referred to herein as ECU 126) which is configured to control operation of braking system 106. ECU 126 is operatively coupled with communication links 150 and configured for operative communication with other components of ECS 110 via communication links 150. ECU 126 has authority over the execution of commands to control braking system 106. ECU 126 may be configured and provided as an EA ECU and may therefore have authority the execution of VMC commands to control braking system 106 to effect control over the motion of vehicle system 100. ECU 124 may include base controls and ADS controls similar to the base controls and ADS controls of ECU 140, but configured and executable to control operation of steering system 104.

With reference to FIG. 2 there is illustrated an example architecture of vehicle controls 200 which may be implemented in connection with one or more components of an electronic control system of a vehicle such as ECS 110 or another ECS including a plurality of ADS ECUs and at least one EA ECU having execution authority over vehicle motion control (VMC) commands.

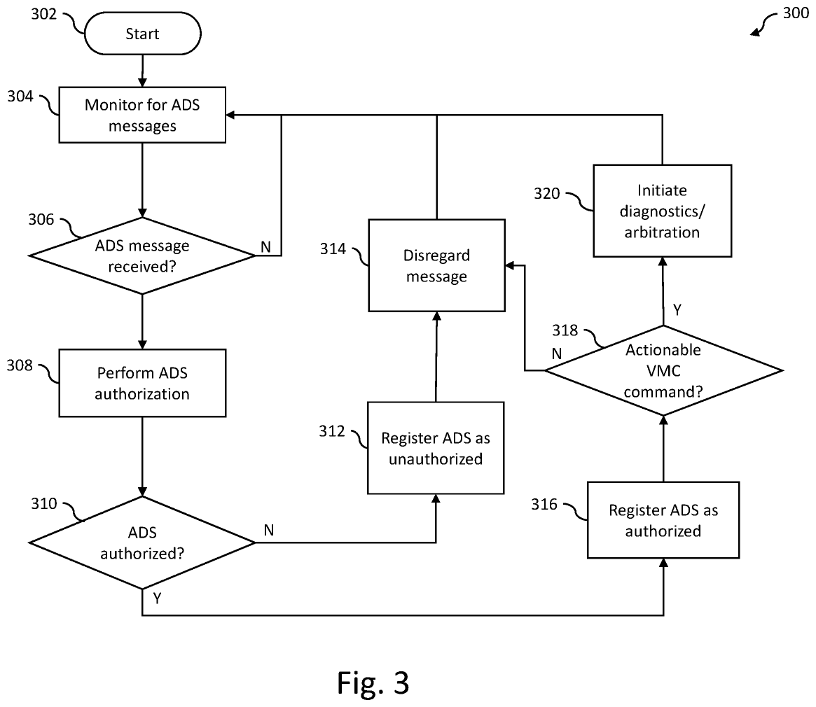

Vehicle controls 200 include identification and authorization controls 210 (also referred to herein as controls 210). Controls 210 are configured and executable to identify and/or authorize participation of a plurality of ADS ECUs in vehicle motion control operations executed by an EA ECU. In some embodiments, controls 210 may be configured to execute an ADS identification and authorization process such as the identification and authorization aspects of process 300 described in connection with FIG. 3.

Vehicle controls 200 include ADS message reception controls 220 (also referred to herein as controls 220). Controls 220 are configured and executable to perform ADS message reception from a plurality of ADS ECUs which have been identified and authorized by or in connection with the operation of controls 210. In some embodiments, controls 220 may be configure to execute an ADS message reception process such as the message reception operations of process 300 described in connection with FIG. 3.

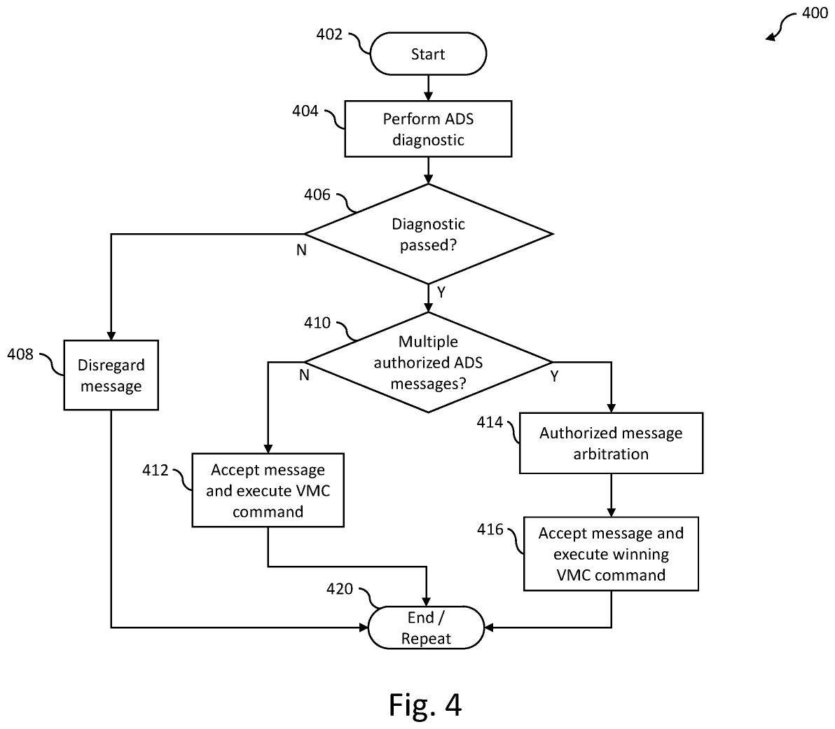

Vehicle controls 200 include ADS diagnostics controls 230 (also referred to herein as controls 230). Controls 230 are configured and executable to perform ADS diagnostics using ADS message received from a plurality of ADS ECUs by or in connection with the operation of controls 220. In some embodiments, controls 220 may be configure to execute an ADS diagnostics process such as the diagnostic operations of process 400 described in connection FIG. 4.

Vehicle controls 200 include ADS arbitration controls 235 (also referred to herein as controls 235). Controls 235 are configured and executable to perform ADS arbitration using ADS message received from a plurality of ADS ECUs by or in connection with the operation of controls 220. In some embodiments, controls 220 may be configure to execute an ADS arbitration process such as the arbitration operations of process 400 described in connection FIG. 4.

Vehicle controls 200 include VMC command execution controls 240 (also referred to herein as controls 240). Controls 240 are configured and executable to execute VMC commands selected by or in connection with operation of controls 235. In some embodiments, controls 220 may be configure to execute a VMC command execution process such as the execution operations of process 400 described in connection FIG. 4.

With reference to FIG. 3 there is illustrated an example ADS identification and authorization process 300 (also referred to herein as process 300) which may be executed by an ECU such as ECU 140 or another EA ECU of ECS 110. Process 300 is initiated at start operation 302 which may be performed in response to a vehicle key-on event or another system initialization or reset event such as a commissioning event, a calibration event, a service event, or a component replacement event. From start operation 302, process 300 proceeds operation 304.

Operation 304 monitors one or more communication links such as communication links 150 for ADS messages. From operation 304, process 300 proceeds to conditional 306 which evaluates whether an ADS message has been received. If conditional 306 evaluates negative, process 300 proceeds operation 304. If conditional 306 evaluates affirmative, process 300 proceeds to operation 308.

Operation 308 performs an ADS authorization operation. In some embodiments, the ADS authorization operation involve reading one or more predetermined calibration parameters against which one or more parameters of an ADS message may be checked to evaluate an authorization status. The calibration parameters may be established during original production of a vehicle system or a subsequent calibration or service event, for example, based on the installation and/or configuration of ECUs, communication networks, and/or other components of an ECS. Example calibration parameters read by operation 308 may include make and model parameters identifying the make and model of an ADS ECU transmitting an ADS message, network address or ID parameters identifying a network address or ID of an ADS ECU transmitting an ADS message, or combinations of the foregoing parameters, as well as additional or alternative calibration parameters and combinations of calibration parameters. In some embodiments, additional or alternative ADS authorization operations may be performed including, for example, certificate-based, key-based, or other cryptographic authorization operations.

From conditional 308, process 300 proceeds to conditional 310 which evaluates an ADS authorized condition based on the authorization operation of operation 308. In some embodiments, conditional 310 may evaluate an ADS authorized condition by performing a logical comparison between one or more predetermined calibration parameters and one or more parameters of an ADS message. In some embodiments, conditional 310 may evaluate an ADS authorized condition using certificate-based, key-based, or other cryptographic conditional access-type evaluations.

If conditional 310 evaluates negative, process 300 proceeds to operation 312 which registers the ADS associated with the received message as unauthorized. From operation 312, process 300 proceeds operation 314 which disregards the received message for purposes of executing VMC command operations. From operation 314, process 300 proceeds operation 304.

If conditional 310 the value is affirmative, process 300 proceeds to operation 316 which registers the ADS associated with the received message as authorized. From operation 316, process 300 proceeds to conditional 318.

Conditional 318 evaluates whether the received, authorized message includes an actionable VMC command. Conditional 318 may evaluates whether the received, authorized message includes an actionable VMC command by pre-execution processing of a VMC command parameter of a received, authorized ADS message. The pre-execution processing may include, for example, comparing the VMC command parameter to one or more predetermined value indicative of an executable VMC command, evaluating one or more flag parameters of an ADS message, or combinations of the foregoing and/or other evaluations. If conditional 318 evaluates negative, process 300 proceeds operation 314. From operation 314, process 300 proceeds to operation 304.

If conditional 318 evaluates negative, process 300 proceeds operation 314 which disregards the received message for purposes of executing VMC command operations. From operation 314, process 300 proceeds operation 304.

If conditional 318 evaluates affirmative, process 300 proceeds to operation 320. Operation 320 initiates a diagnostic and/or arbitration process, such as process 400 described in connection with FIG. 4. From operation 320, process 300 proceeds to operation 304.

With reference to FIG. 4 there is illustrated an example ADS diagnostic and arbitration process 300 (also referred to herein as process 300) which may be executed by an ECU such as ECU 140 or another EA ECU of ECS 110. Process 400 is initiated at start operation 402 which may be performed in response to an operation of an initialization and authorization process such as operation 320 of process 300. From start operation 402, process 400 proceeds operation 404.

Operation 404 performs an ADS diagnostic using one or more received, authorized ADS messages. In some embodiments, the timing of received ADS messages may be compared to a message time out parameter which expires after a predetermined delay and may be reset by a received ADS message. In such embodiments, operation 404 may base a diagnostic on the whether or not the time out parameter evaluates true. In some embodiment, such evaluation may be performed in combination with other evaluations according to the present disclosure.

In some embodiments, received ADS messages may be transmitted according to a predetermined frequency or timing which can utilized by operation 404 as a diagnostic basis. The predetermined frequency or timing may be defined by a communication protocol or other reference basis utilized by operation 404. In some forms, operation 404 may passively check characteristics of received ADS messages relative without actively querying for the ADS messages. In some forms, operation 404 may actively request or query for ADS messages. The predetermined frequency or timing may apply to all ADS messages, all ADS messages originating from a given ADS ECU, or to certain ADS messages such as discrete heartbeat-type messages. In such embodiments, operation 404 may perform the ADS diagnostic by evaluating the frequency or timing of received ADS messages against an established or expected standard and may apply additional diagnostic criteria or heuristics, such as, a count of missed expected messages which may be measured sequentially or on average to diagnostic the communication status of an ADS ECU. In some forms of such embodiments, such evaluation may be performed in combination with other evaluations according to the present disclosure.

In some embodiments, received ADS messages may include a self-reported diagnostic status parameter determined by ADS ECUs that transmitted the received ADS messages. In such embodiments, operation 404 may perform the ADS diagnostic by evaluating the self-reported diagnostic status parameter. In some forms of such embodiment, such evaluation may be performed in combination with other evaluations according to the present disclosure.

In some embodiments, received ADS messages may include identifying parameter for their respective ADS ECUs that may be utilized by operation 404 in performing an ADS diagnostic. In some such embodiments, operation 404 may rely on an ECU external to the ECU executing operation 404. For example, an EA ECU may delegate or otherwise rely on a second ECU in operative communication with the EA ECU over one or more communication networks to provide a diagnostic parameter which may be utilized by operation 404 in performing an ADS diagnostic. As a further example, in the context of FIG. 1, ECU 140 may delegate one or more diagnostic activities to another ECU, for example, a braking system ECU such as ECU 126. The delegated diagnostic activities may include one or more of the diagnostic activities or evaluates described herein. The other ECU, for example, braking ECU 126 may configured and operable to transmit diagnostic parameters to the ECU of operation 404, which operation 404 may reference or otherwise utilize in combination with a one or more ADS messages.

From operation 404, process 400 proceeds to conditional 406 which evaluates whether a diagnostic passed condition is true. If conditional 406 evaluates negative, process 400 proceeds to operation 408 which disregards the received ADS message for purposes of executing VMC command operations. From operation 408, recess process 400 proceeds to operation 420 which ends or suspends a current execution of process 400 which may be later executed, repeated, or reactivated.

If conditional 406 evaluates affirmative, process 400 proceeds to conditional 410 which evaluates whether multiple authorized ADS messages have been received. If conditional 410 evaluates negative, process 400 proceeds to operation 412. Operation 412 accepts a single received authorized ADS messages for purposes of vehicle motion control and executes, or initiates or authorizes execution of, a VMC command of single received, authorized ADS message. From operation 408, process 400 proceeds to operation 420 whose operation is as described above.

If conditional 410 evaluates affirmative, process 400 proceeds to operation 414. Operation 414 performs an arbitration between two or more received ADS messages. While conditional 410 is depicted as following conditional 406 in the illustrated example, conditionals 406 and 410 and/or their corresponding evaluations may be differently arranged or ordered in other embodiments including, for example, with conditional 410 preceding and/or leading to conditional 406, or conditional 406 and conditional 410 being performed in parallel or non-sequential execution paths.

Operation 414 may perform a number of types of arbitrations. In some forms, received ADS messages may include and execution priority parameter which may be utilized by operation 414 to arbitrate between two or more ADS messages, for example, by selecting a message including a higher execution priority parameter than one or more other ADS messages as a winning ADS message. In some forms the execution priority parameter may be a field or component of an ADS message dedicated to specifying execution priority. In some forms the execution priority parameter may be a dual-purposes field or component of an ADS message, such as make and model parameters identifying the make and model of an ADS ECU transmitting an ADS message, network address or ID parameters identifying a network address or ID of an ADS ECU transmitting an ADS message, or combinations of the foregoing parameters. Such arbitration may be performed in combination with other arbitration operations according to the present disclosure.

In some forms, received ADS messages may include or may be associated with a time of transmission or a time of receipt which may be utilized by operation 414 to arbitrate between two or more ADS messages, for example, by selecting a message including an earlier time or a later time than one or more other ADS messages as a winning ADS message. Such arbitration may be performed in combination with other arbitration operations according to the present disclosure.

In some forms, operation 414 may utilize received ADS messages may be utilized in combination with diagnostic characteristics such as those described above in connection with operation 404 and conditional 406 in performing arbitration operations. For example, operation 414 may be configured to arbitration by selecting a message including a superior or preferred diagnostic status than one or more other ADS messages as a winning ADS message. In some such embodiments, the diagnostic status may be provided to operation 414 by one or more other ECUS to which one or more diagnostic aspects has been delegated. Such arbitration may be performed in combination with other arbitration operations according to the present disclosure.

From operation 414, process 400 proceeds to operation 416. Operation 416 accepts a winning received authorized ADS messages indicated or selected by operation 414 for purposes of vehicle motion control and executes, or initiates or authorizes execution of, a VMC command of the winning received, authorized ADS message. From operation 416, process 400 proceeds to operation 420 whose operation is as described above.

As illustrated by this detailed description, the present disclosure contemplates a plurality of embodiments including the following examples. A first example embodiment is a vehicle system comprising: a plurality of automated driving system electronic control units (ADS ECUs) configured to determine vehicle motion control (VMC) commands in response to input from one or more vehicle environment sensors and transmit messages including the VMC commands over one or more communication links; and an execution authority electronic control unit (EA ECU) configured with execution authority over one or more VMC commands and configured to: receive via the one or more communication links a first message transmitted by a first one of the plurality of ADS ECUs and including a first VMC command and a second message transmitted by a second one of the plurality of ADS ECUs and including a second VMC command, select one of the first VMC command and the second VMC command in response to an arbitration based upon information of the first message and the second message, and control motion of the vehicle system using the selected one of the first VMC command and the second VMC command.

A second example embodiment includes the features of the first example embodiment, wherein the EA ECU is configured to: determine a first authorization status of the first one of the plurality of ADS ECUs based upon information of the first message, and determine a second authorization status of the second one of the plurality of ADS ECUs based upon information of the first message.

A third example embodiment includes the features of the second example embodiment, wherein the EA ECU is configured to: determine the first authorization in response to the information of the first message and a first predetermined calibration parameter, and determine the second authorization in response to the information of the second message and a second predetermined calibration parameter.

A fourth example embodiment includes the features of the first example embodiment, wherein the EA ECU is configured to: determine a first diagnostic status of the first one of the plurality of ADS ECUs based upon information of the first message, and determine a second diagnostic status of the second one of the plurality of ADS ECUs based upon information of the first message.

A fifth example embodiment includes the features of the fourth example embodiment, wherein the arbitration is based at least in part upon the first diagnostic status and the second diagnostic status.

A sixth example embodiment includes the features of the fourth example embodiment, wherein the EA ECU is configured to: determine the first diagnostic status based upon information received from a second ECU, the second ECU being in operative communication with the EA ECU via at least one of the one or more communication links.

A seventh example embodiment includes the features of the sixth example embodiment, wherein the second ECU is a braking system ECU.

An eighth example embodiment is a process comprising: operating a plurality of automated driving system electronic control units (ADS ECUs) to perform the acts of determining vehicle motion control (VMC) commands in response to input from one or more vehicle environment sensors and transmitting messages including the VMC commands over one or more communication links; and operating an execution authority electronic control unit (EA ECU) configured with execution authority over one or more VMC commands to perform the acts of: receiving via the one or more communication links a first message transmitted by a first one of the plurality of ADS ECUs and including a first VMC command and a second message transmitted by a second one of the plurality of ADS ECUs and including a second VMC command, selecting one of the first VMC command and the second VMC command in response to an arbitration based upon information of the first message and the second message, and controlling motion of the vehicle system using the selected one of the first VMC command and the second VMC command.

A ninth example embodiment includes the features of the eighth example embodiment, and comprises operating the EA ECU to perform the acts of: determining a first authorization status of the first one of the plurality of ADS ECUs based upon information of the first message, and determining a second authorization status of the second one of the plurality of ADS ECUs based upon information of the first message.

A tenth example embodiment includes the features of the ninth example embodiment, and comprises operating the EA ECU to perform the acts of: determining the first authorization in response to the information of the first message and a first predetermined calibration parameter, and determining the second authorization in response to the information of the second message and a second predetermined calibration parameter.

An eleventh example embodiment includes the features of the eighth example embodiment, and comprises operating the EA ECU to perform the acts of: determining a first diagnostic status of the first one of the plurality of ADS ECUs based upon information of the first message, and determining a second diagnostic status of the second one of the plurality of ADS ECUs based upon information of the first message.

A twelfth example embodiment includes the features of the eleventh example embodiment, wherein the arbitration is based at least in part upon the first diagnostic status and the second diagnostic status.

A thirteenth example embodiment includes the features of the eleventh example embodiment, and comprises operating the EA ECU to perform the act of: determining the first diagnostic status based upon information received from a second ECU, the second ECU being in operative communication with the EA ECU via at least one of the one or more communication links.

A fourteenth example embodiment includes the features of the thirteenth example embodiment, wherein the second ECU is a braking system ECU.

A fifteenth example embodiment is an apparatus comprising: an electronic control system including one or more non-transitory memory media configured to store instructions executable by one or more processors to: operate a plurality of automated driving system electronic control units (ADS ECUs) to determine vehicle motion control (VMC) commands in response to input from one or more vehicle environment sensors and transmit messages including the VMC commands over one or more communication links; and operate an execution authority electronic control unit (EA ECU) configured with execution authority over one or more VMC commands to: receive via the one or more communication links a first message transmitted by a first one of the plurality of ADS ECUs and including a first VMC command and a second message transmitted by a second one of the plurality of ADS ECUs and including a second VMC command, select one of the first VMC command and the second VMC command in response to an arbitration based upon information of the first message and the second message, and control motion of the vehicle system using the selected one of the first VMC command and the second VMC command.

A sixteenth example embodiment includes the features of the fifteenth example embodiment, wherein the instructions are executable by the one or more processors to operate the EA ECU to: determine a first authorization status of the first one of the plurality of ADS ECUs based upon information of the first message, and determine a second authorization status of the second one of the plurality of ADS ECUs based upon information of the first message.

A seventeenth example embodiment includes the features of the sixteenth example embodiment, wherein the instructions are executable by the one or more processors to operate the EA ECU to: determine the first authorization in response to the information of the first message and a first predetermined calibration parameter, and determine the second authorization in response to the information of the second message and a second predetermined calibration parameter.

An eighteenth example embodiment includes the features of the fifteenth example embodiment, wherein the instructions are executable by the one or more processors to operate the EA ECU to: determine a first diagnostic status of the first one of the plurality of ADS ECUs based upon information of the first message, and determine a second diagnostic status of the second one of the plurality of ADS ECUs based upon information of the first message.

A nineteenth example embodiment includes the features of the eighteenth example embodiment, wherein the arbitration is based at least in part upon the first diagnostic status and the second diagnostic status.

A twentieth example embodiment includes the features of the eighteenth example embodiment, wherein the instructions are executable by the one or more processors to operate the EA ECU to: determine the first diagnostic status based upon information received from a second ECU, the second ECU being in operative communication with the EA ECU via at least one of the one or more communication links.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A vehicle system comprising:
a plurality of automated driving system electronic control units (ADS ECUs) configured to determine vehicle motion control (VMC) commands in response to input from one or more vehicle environment sensors and transmit messages including the VMC commands over one or more communication links; and
an execution authority electronic control unit (EA ECU) configured with execution authority over one or more VMC commands and configured to:
receive via the one or more communication links a first message transmitted by a first one of the plurality of ADS ECUs and including a first VMC command and a second message transmitted by a second one of the plurality of ADS ECUs and including a second VMC command,
select one of the first VMC command and the second VMC command in response to an arbitration based upon information of the first message and the second message, and
control motion of the vehicle system using the selected one of the first VMC command and the second VMC command.

2. The vehicle system of claim 1, wherein the EA ECU is configured to:
determine a first authorization status of the first one of the plurality of ADS ECUs based upon information of the first message, and
determine a second authorization status of the second one of the plurality of ADS ECUs based upon information of the first message.

3. The vehicle system of claim 2, wherein the EA ECU is configured to:
determine the first authorization in response to the information of the first message and a first predetermined calibration parameter, and
determine the second authorization in response to the information of the second message and a second predetermined calibration parameter.

4. The vehicle system of claim 1, wherein the EA ECU is configured to:
determine a first diagnostic status of the first one of the plurality of ADS ECUs based upon information of the first message, and
determine a second diagnostic status of the second one of the plurality of ADS ECUs based upon information of the first message.

5. The vehicle system of claim 4, wherein the arbitration is based at least in part upon the first diagnostic status and the second diagnostic status.

6. The vehicle system of claim 4, wherein the EA ECU is configured to:
determine the first diagnostic status based upon information received from a second ECU, the second ECU being in operative communication with the EA ECU via at least one of the one or more communication links.

7. The vehicle system of claim 6, wherein the second ECU is a braking system ECU.

8. A process comprising:
operating a plurality of automated driving system electronic control units (ADS ECUs) to perform the acts of determining vehicle motion control (VMC) commands in response to input from one or more vehicle environment sensors and transmitting messages including the VMC commands over one or more communication links; and
operating an execution authority electronic control unit (EA ECU) configured with execution authority over one or more VMC commands to perform the acts of:
receiving via the one or more communication links a first message transmitted by a first one of the plurality of ADS ECUs and including a first VMC command and a second message transmitted by a second one of the plurality of ADS ECUs and including a second VMC command,
selecting one of the first VMC command and the second VMC command in response to an arbitration based upon information of the first message and the second message, and
controlling motion of the vehicle system using the selected one of the first VMC command and the second VMC command.

9. The process of claim 8, comprising operating the EA ECU to perform the acts of:
determining a first authorization status of the first one of the plurality of ADS ECUs based upon information of the first message, and
determining a second authorization status of the second one of the plurality of ADS ECUs based upon information of the first message.

10. The process of claim 9, comprising operating the EA ECU to perform the acts of:
determining the first authorization in response to the information of the first message and a first predetermined calibration parameter, and
determining the second authorization in response to the information of the second message and a second predetermined calibration parameter.

11. The process of claim 8, comprising operating the EA ECU to perform the acts of:
determining a first diagnostic status of the first one of the plurality of ADS ECUs based upon information of the first message, and
determining a second diagnostic status of the second one of the plurality of ADS ECUS based upon information of the first message.

12. The process of claim 11, wherein the arbitration is based at least in part upon the first diagnostic status and the second diagnostic status.

13. The process of claim 11, comprising operating the EA ECU to perform the act of:
determining the first diagnostic status based upon information received from a second ECU, the second ECU being in operative communication with the EA ECU via at least one of the one or more communication links.

14. The process of claim 13, wherein the second ECU is a braking system ECU.

15. An apparatus comprising:
an electronic control system including one or more non-transitory memory media configured to store instructions executable by one or more processors to:
operate a plurality of automated driving system electronic control units (ADS ECUs) to determine vehicle motion control (VMC) commands in response to input from one or more vehicle environment sensors and transmit messages including the VMC commands over one or more communication links; and
operate an execution authority electronic control unit (EA ECU) configured with execution authority over one or more VMC commands to:
receive via the one or more communication links a first message transmitted by a first one of the plurality of ADS ECUs and including a first VMC command and a second message transmitted by a second one of the plurality of ADS ECUs and including a second VMC command,
select one of the first VMC command and the second VMC command in response to an arbitration based upon information of the first message and the second message, and
control motion of the vehicle system using the selected one of the first VMC command and the second VMC command.

16. The apparatus of claim 15, wherein the instructions are executable by the one or more processors to operate the EA ECU to:
determine a first authorization status of the first one of the plurality of ADS ECUs based upon information of the first message, and
determine a second authorization status of the second one of the plurality of ADS ECUs based upon information of the first message.

17. The apparatus of claim 16, wherein the instructions are executable by the one or more processors to operate the EA ECU to:
determine the first authorization in response to the information of the first message and a first predetermined calibration parameter, and
determine the second authorization in response to the information of the second message and a second predetermined calibration parameter.

18. The apparatus of claim 15, wherein the instructions are executable by the one or more processors to operate the EA ECU to:
determine a first diagnostic status of the first one of the plurality of ADS ECUs based upon information of the first message, and
determine a second diagnostic status of the second one of the plurality of ADS ECUs based upon information of the first message.

19. The apparatus of claim 18, wherein the arbitration is based at least in part upon the first diagnostic status and the second diagnostic status.

20. The apparatus of claim 18, wherein the instructions are executable by the one or more processors to operate the EA ECU to:
determine the first diagnostic status based upon information received from a second ECU, the second ECU being in operative communication with the EA ECU via at least one of the one or more communication links.
